(19) United States
(12) Patent Application Publication
(10) Pub. No.: US 2014/0143073 A1
(43) Pub. Date: May 22, 2014

(54) Converted Currency Display

(71) Applicant: Abraham Doris-Down, Austin, TX (US)

(72) Inventor: Abraham Doris-Down, Austin, TX (US)

(21) Appl. No.: 13/679,788

(22) Filed: Nov. 16, 2012

(51) Int. Cl. G06Q 30/06

(52) U.S. Cl. CPC G06Q 30/0601
USPC 705/16; 705/26.1

(57) ABSTRACT

Methods and systems are provided for converting prices of products from a local currency of a merchant to a preferred currency of a shopper. The conversion can be performed automatically and the shopper's preferred currency product price can displayed when the shopper is at a place where such price information is typically desired. For example, the shopper's preferred currency product price can be displayed on a product display or on a point of sale (POS) display. The shopper's preferred currency product price can be displayed on a mobile device of the shopper.

### BACKGROUND

1. Technical Field

The present disclosure generally relates to electronics and, more particularly, relates to methods and systems for automatically displaying product prices of a merchant in a preferred currency of a shopper.

2. Related Art

Currency conversion is a common problem for shoppers traveling outside of their native country. Often, a traveling shopper will attempt to mentally convert from a price displayed in a merchant's local currency to the equivalent price in the shopper's native or preferred currency. However, such mental conversion can sometimes be difficult and is subject to error.

Currency converters are well known. A currency converter can be a dedicated electronic device or can be an app for mobile device such as a cellular telephone or portable computer. Although currency converters can be accurate and reliable, they can be inconvenient to use. For example, the shopper may have to initiate the currency conversion app on the shopper's mobile device, enter the money amount in the merchant's local currency, select the merchant's local currency type, select the user's preferred currency type, and then note the money amount in the shopper's preferred currency. Of course, the shopper must carry the currency converter in order to use it.

Further, currency converters require that an up-to-date exchange rate be provided. Often, the exchange rate can be obtained from the Internet. However, if an Internet connection is not available, then an accurate exchange rate may not be used, resulting in an inaccurate currency conversion.

### BRIEF DESCRIPTION OF THE DRAWINGS

FIG. 1 is a block diagram of a system for converting and displaying currencies, according to an embodiment;

FIG. 2 is a flow chart showing a method for converting and displaying currencies, according to an embodiment;

FIG. 3 is a flow chart showing further detail of the method for converting and displaying currencies, according to an embodiment; and

FIG. 4 is a block diagram of an example of a computer that is suitable for use in the system for converting and displaying currencies, according to an embodiment.

### DETAILED DESCRIPTION

Methods and systems are provided for converting prices of products from a local currency of a merchant to a native or preferred currency of a shopper or user. Thus, the user is spared the inconvenience of having to mentally convert from a price displayed in the local currency to the equivalent price in the user's preferred currency or from having to use a currency convertor to perform the conversion.

According to an embodiment, the conversion can be performed automatically and the user's preferred currency product price can be displayed when the user is at a place where such price information is typically desired. For example, the user's preferred currency product price can be displayed on a product display or on a point of sale (POS) display. The user's preferred currency product price can be displayed on a mobile device of the user. The conversion and the display can occur substantially in real time.

According to an embodiment, a system can comprise one or more memories that store one or more currency conversion rates for converting from a local currency of a merchant to a preferred currency of a user. The one or more memories can also store one or more local currency product prices. The currency conversion rates can be stored in a different memory with respect to the local currency product prices.

One or more processors can be operable to receive a communication, such as a wireless communication, including an indication of the preferred currency of the user. The communication can be received from a user's mobile device that is located within a store of the merchant. The one or more processors can access, in the one or more memories, the currency conversion rate. The one or more processors can access, in the one or more memories, the local currency product price. The one or more processors can determine, from the currency conversion rate and the local currency product price, a preferred currency product price and can provide a signal for displaying the preferred currency product price.

The signal can facilitate displaying of the preferred currency product price on a display within the store, such as a display near the user so that the user can better determine whether or not to purchase the product. The signal can contain or be representative of the preferred currency product price. The signal can also contain or be representative of the currency type or symbol for preferred currency product price. For example, the signal can be configured to display the currency type or symbol “U.S. Dollars”, “USD”, or “US$” next to the preferred currency product price.

The display can be a product display, a point of sell display, the display of the user's mobile device, or any other display. Thus, the signal can be provided for displaying the preferred currency product price on a product display, the signal can be provided for displaying the preferred currency product price on a point of sale display, and/or the signal can be provided for displaying the preferred currency product price on a user's mobile device or on any other device.

The preferred currency product price can be a unit price, e.g., a price for one product. The preferred currency product price can be a total price for a plurality of products. The preferred currency product price can include or exclude any costs or fees, such as sales tax, value added tax, (VAT), delivery charge, and the like.

The signal can also be a signal for displaying a message. The message can relate to the displayed preferred currency product price. For example, the message can offer a discount for using the merchant's local currency rather than the user's preferred currency.

The message can provide information that is or is not related to the displayed preferred currency product price. The message can contain advertising or promotional material. For example, the message can recommend another product that is currently on sale and/or can recommend other products that can be purchased along with the product of the displayed price wherein the other products can be used therewith.

The message can contain information regarding the store where the user is presently shopping, regarding products sold in the store where the user is presently shopping, regarding any other store, and/or regarding any other products. The message can contain information regard television shows, movies, theatrical events, sports events, concerts, cellular telephones deals, or the like. The message can contain text information, graphic information, audio information, video information, or any other kind of information. The message can contain any desired information.

According to an embodiment, a method can comprise storing, in one or more memories, a currency conversion rate for converting from a local currency of a merchant to a preferred currency of a user. A local currency product price can be stored in the one or more memories. The method can include any of the steps or combination of steps discussed herein.

A communication including an indication of the preferred currency of the user can be received electronically by one or more processors. The currency conversion rate can be accessed, electronically by the one or more processors, in the one or more memories. The local currency product price can be accessed, electronically by one or more processors, in the one or more memories.

A preferred currency product price can be determined, electronically by one or more processors, from the currency conversion rate and the local currency product price. A signal for displaying the preferred currency product price can be provided electronically by one or more processors.

According to an embodiment, a computer program product can comprise a non-transitory computer readable medium having computer readable and executable code for instructing one or more processors to perform the method.

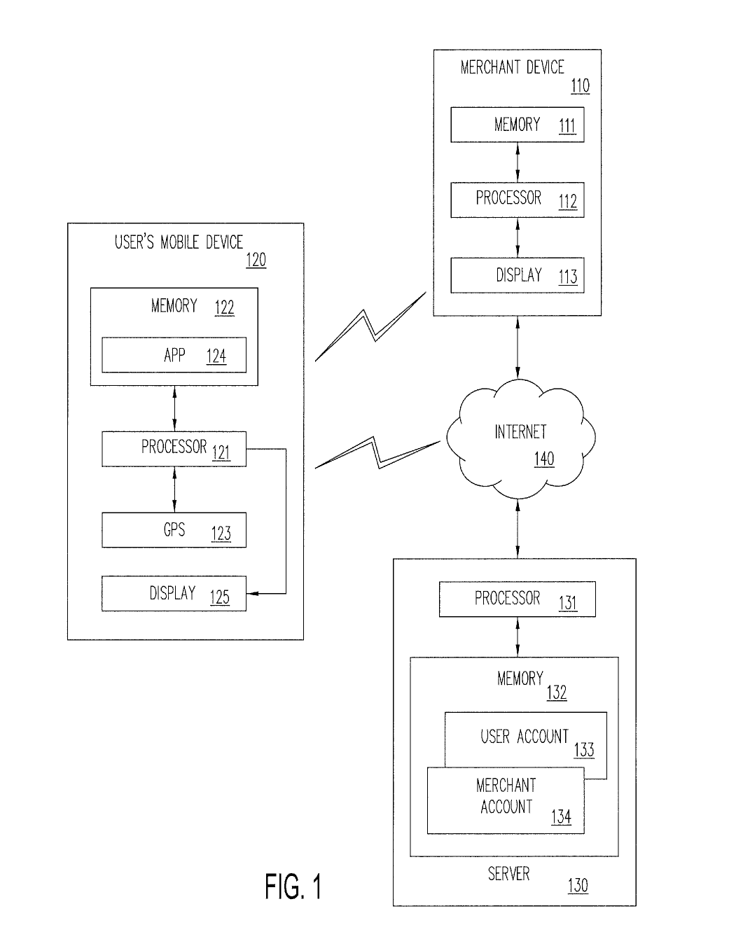

FIG. 1 is a block diagram of a system for converting and displaying currencies, according to an embodiment. The system can include a merchant device 110. The merchant device 110 can be a merchant checkout terminal, a computer, and/or a server, for example. The merchant device 110 can include a memory 111, a processor 112, and a display 113. The merchant device 110 can be used for maintaining a database of currency conversion rates, for maintaining a database of product prices (such as in a merchant's local currency), and/or for determining product prices in various different currencies.

More particularly, the memory 111 can store one or more currency conversion rates and the processor 112 can convert a merchant's local product price, e.g., a local currency product price of the merchant, into a user's native currency product price, e.g., a preferred currency product price of the user. Thus, currency conversion can be performed substantially autonomously by the merchant device 110. Alternatively, the currency conversion rates can be stored in a memory of a device other than the merchant device 110 and/or the currency conversion can be performed by a processor of a device other than the merchant device 110, as discussed herein.

The memory 111 can comprise one or more memories of one or more devices. For example, the memory 111 can comprise a memory of a point of sale device and a memory of a product display device. Similarly, the processor 112 can comprise one or more processors of one or more devices. For example, the processor 112 can comprise a processor of a point of sale device and a processor of a product display device. Similarly, the display 113 can comprise one or more displays of one or more devices. For example, the display 113 can comprise a display of a point of sale device and a display of a product display device.

The merchant device 110 can be or can include a point of sale device. For example, the merchant device can be located at a checkout counter of a store. The display 113 can be a display of the checkout counter, such as a display upon which the user can view prices of products purchased as they are being rung up and upon which the user can view a total for all of the products purchased.

The merchant device 110 can be or can include a product display device. For example, the merchant device can be located proximate displayed inventory of a store. The display 113 can be a display of the product display device, such as a display upon which the user can view a price of the products displayed nearby. For example, the product display can be attached to a shelf or end cap upon which the product is displayed.

Any number of merchant devices 110 can be used. For example, the system can comprise a number, e.g., 1, 5, 10, or more, point of sale merchant devices 110. As a further example, the system can comprise a larger number, e.g., 1000, 10,000, 50,000 or more of product display merchant devices 110.

The display 113 can be a light emitting diode (LED) display, an e-ink display, or an e-paper display. The display 113 can be any desired type of display. A separate display 113 can be provided for each product sold by the merchant. A display 113 can be provided only for selected products sold by the merchant or a display 113 can be provided for substantially all of the products sold by the merchant.

The system can include a mobile device 120. The mobile device 120 can be carried by the user. The mobile device 120 can be a cellular telephone, a smart telephone, a hand held computer, a laptop computer, a notebook computer, or a tablet computer, for example. The mobile device 120 can include a processor 121, a memory 122, a global positioning system (GPS) 123, and a display 125.

The GPS 123 can trigger the transmission of the communication from the mobile device 120 that is indicative of the user's preferred currency or currencies. For example, the GPS 123 can trigger the transmission of the communication from the mobile device 120 that is indicative of the user's preferred currency or currencies when the user's mobile device is proximate know location of a merchant device 110 or a known location of a store containing merchant device 110.

An app 124 can be stored in the memory 122 and executed by the processor 121. The app 124 can be used for currency conversion. The app 124 can perform currency conversion or the app 124 can cooperate with another device (such as the merchant device 110 or the server 130) that performs the currency conversion.

More particularly, the memory 122 can store one or more currency conversion rates and the processor 121 can be operable to convert a merchant's local product price, e.g., a local currency product price, to a user's native currency product price, e.g., a preferred currency product price. Thus, currency conversion can be performed autonomously by the user's mobile device 120. Alternatively, the currency conversion rates can be stored in a memory of a device other than the user's mobile device 120 and/or the currency conversion can be performed by a processor of a device other than the merchant device user's mobile device 120, as discussed herein.

The system can include a server 130. The server 130 can be a server of a payment provider, such as PayPal, Inc. The server 130 can be a single server or can be a plurality of servers. The server 130 can include one or more processors 131 and a memory 132. The memory 132 can be a memory of the server 130 or a memory that is associated with the server 130. The memory 132 can be a distributed memory. The memory 132 can store a user account 133 and a merchant account 134. The user account 130 can contain information regarding the user such as the user's preferred currency or currencies. The merchant account 134 can contain information regarding the merchant such as the merchant's local currency and/or prices of products sold by the merchant in the merchant's local currency.

The server 130 can be a currency conversion server. The server 130 can be a dedicated currency conversion server. The server 130 can be used for maintaining an updated database of currency conversion rates and/or for determining product prices in various different currencies. More particularly, the memory 132 can store one or more currency conversion rates and the processor 131 can be operable to convert a merchant's local product price, e.g., a local currency product price, to a user's native currency product price, e.g., a preferred currency product price. Thus, currency conversion can be performed autonomously by the server 130. Alternatively, the currency conversion rates can be stored in a memory of a device other than the merchant device 110 and/or the currency conversion can be performed by a processor of a device other than the merchant device, as discussed herein.

The result of the currency conversion, e.g., the preferred currency product price, can be displayed anywhere desired, regarding of where the currency conversion rates are store and regardless of where the currency conversion is performed. For example, the preferred currency product price can be displayed by the user's mobile device 120, by a display of the merchant (such as a product display or a point of sale display) or by any other display.

The processor 112 of the merchant device 100, the processor 121 of the mobile device and/or the processor 131 of the server 130 can cooperate to perform the currency conversion. The processor of any device or combination of devices can perform the currency conversion.

The memory 111 of the merchant device 100, the memory 122 of the mobile device, and/or the memory 132 of the server 130 can cooperate to store product prices and/or currency conversion rates to facilitate currency conversion. The memory of any device or combination of devices can store information used for the currency conversion.

Any combination of the merchant device 110, the mobile device 120, and the server 130 can maintain a database of currency conversion rates and can determine product prices in various different currencies. One or more other devices can maintain a database of currency conversion rates and for determining product prices in various different currencies.

The merchant device 110, the mobile device 120, and the server 130 can communicate with one another via a network, such as the Internet 140. The merchant device 110, the mobile device 120, and the server 130 can communicate with one another via one or more networks, such as local area networks (LANs), wide area networks (WANs), cellular telephone networks, and the like. The merchant device 110, the mobile device 120, the social network 150, and the server 130 can communicate with one another, at least partially, via one or more near field communications (NFC) methods or other short range communications methods, such as infrared (IR), radio frequency ID (RFID), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The display upon which the user's preferred currency product price (the currency converted product price) is shown can be the display 113 of the merchant device 110, the display 125 of the user's mobile device 120, or any other desired display. The display can be located within the merchant's store, within another store, and/or outside of the merchant's store. For example, the display can be in a window, on a marquee, on a billboard, on a television, on a cellular telephone, or on any other display. The display can be located within, near, outside of, or remotely with respect to the merchant's store.

For example, the display can be a billboard located many miles from the merchant's store. The product price normally shown (by default) on the billboard can be in the merchant's local currency. When the user drives by the billboard, the merchant device 110, disposed at or partially at the billboard, can receive a communication from the user's mobile device 120 that is indicative of the user's preferred currency and can change the displayed product price from the merchant's local currency to the user's preferred currency.

Televisions and radios can respond in a manner similar to the billboard. When a signal from the user's mobile device 120 indicative of the user's preferred currency is received, any product prices can be provided in the user's preferred currency.

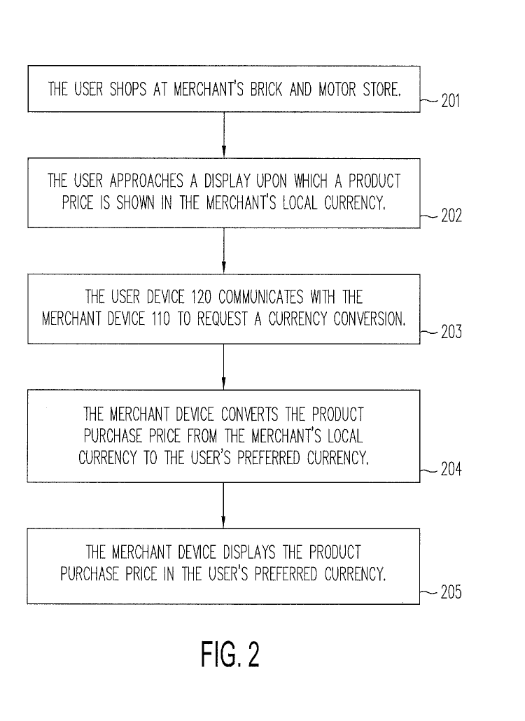

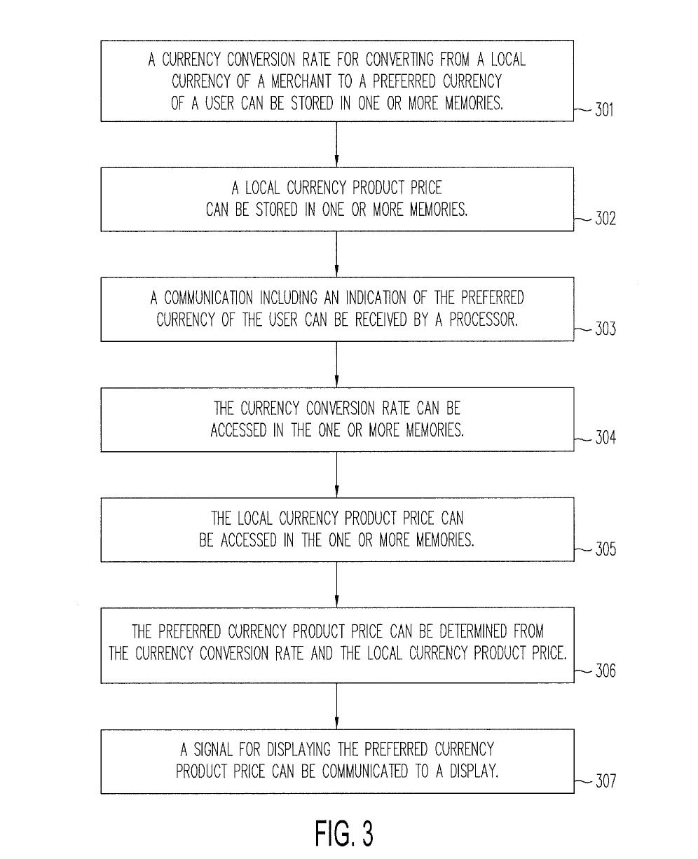

FIGS. 2 and 3 are flow charts that describe examples of operation of the system and method for converting and displaying currencies according to embodiments thereof. Note that one or more of the steps described herein may be combined, omitted, or performed in a different order, as desired or appropriate.

FIG. 2 is a flow chart showing a method for converting and displaying currencies, according to an embodiment. The user can shop at a merchant's brick and mortar store, as shown in step 201. For example, the user can be an American and the user can be shopping at a store in Mexico. Generally, the user can be from any country (that is, the user can use or prefer any currency from any country, thus defining the user's preferred currency) and the store can be in any other country (that is, the merchant can use any other currency, e.g., the merchants native currency).

The user can approach a display 113 upon which a product price is presently shown or is about to be shown in the merchant's local currency, as shown in step 202. In this example, the product price will be shown in pesos since the brick and mortar store is in Mexico. For example, the product price can be presently shown on a product display attached to a shelf next to the product to be purchased. As a further example, the product prices can be about to be shown on a point of sale display at the checkout counter as the checkout clerk rings up the purchase.

Thus, the display 113 can be a product display, e.g., a display where the product is located. For example, the user can be pushing a shopping cart down an aisle of a market and the display 113 can be an electronic display on a shelf upon which the price is shown. The product price can be a price for products proximate the display 113 on the shelf, e.g., the displayed inventory of the merchant. The use of the system described herein facilitates showing of the product prices on product displays in the user's preferred currency.

The display 113 can be a point of sale display. For example, the display 113 can be a point of sale display at the cash register or checkout counter of the store upon which one or more product prices and a total price will be shown for the user's purchases when the user checks out, e.g. when the user's purchases are rung up (such as by a checkout clerk of the store).

Any number and combination of displays 113 can be used. For example, the store can have a product display for one or more products on the shelves and can also have a point of sale display at each one of a plurality of checkout counters. The product displays can show the product price for the associated products for the user to view as the user shops.

The point of sale display can show the product prices as the products are being rung up (scanned or entered by the checkout clerk or by the user for self-checkout systems). The point of sale display can show the total of the product prices when the scanning or entering process is complete. The point of sale display can show any desired subtotal of the product prices before the scanning or entering process is complete. The use of the system described herein facilitates such showing of the product prices, totals, and subtotals on the point of sale display in the user's preferred currency.

The display 113 can be a screen, such as a computer, television, or display screen that is located proximate display products inventory on a shelf or that is located at the checkout counter. The display 113 can be a light emitting diode (LED) display, an e-ink display, or an e-paper display. The display 113 can be any electronic or other display that is associated with the product and/or can show a price for the product.

The merchant's local price can be shown on a fixed or static display, such as a printed paper or paperboard display. The user' desire currency price can be shown on a changeable or dynamic display. The dynamic display can be next to the static display, such as along side thereof and attached to a shelf. The merchant's local price can be shown on the product.

The user device 120 can communicate with the merchant device 110 to request or provide information about a currency conversion, as shown in step 203. The communication can be via near field communication (NFC) or can be via a network. The communication can be via any desired means. The communication can include a designation of one or more preferred currencies of the user. In one embodiment, the communication includes an indication of the device “home” address, such as country of the device phone number or country of device registration, and/or information from a user account associated with the user device, such as user home address, user shipping address, or user specified preferences. For example, the user may specify a preferred currency, even though the preferred currency is not the user's “home” currency. This may be the case when the user is traveling in first country with a companion from a second country, where the user will be making purchases for the companion. When more than one preferred currency of the user is designated, the preferred currencies of the user can be listed in an order of preference. Thus, when converted, the preferred currencies can be shown on the display 113 in the same order, e.g., the user's order of preference. Of note is that the user need not specify one or more preferred currencies, but instead information communicated from the user device may automatically suggest a preferred currency. Thus, “preferred currency” as used herein may be specifically set by the user, determined by a service provider or merchant, or by the user device itself. For example, a preferred currency can be inferred from online purchases, a home address, a telephone number, credit information, credit card information, bank information, payment provider information, social network information, or any other information. The preferred currency can be inferred from any such information regarding the user. The information can be communicated from the user (e.g., the user device) or can be obtained elsewhere such as online (via a social network for example).

The money amount of the preferred currency or currencies can be displayed along with the currency type or symbol. For example, the currency type or symbol “U.S. Dollars”, “USD”, or “US$” can appear next to a money amount that is shown on the display 113 in United States dollars.

As discussed herein, the user's mobile device 120 can be a cellular telephone, a portable computing device, a dedicated chip (dedicated to communicating or broadcasting the user's preferred currency, preferred currencies, or a signal representative thereof), or the like.

The user's mobile device 120 can communication the user's preferred currency or preferred currencies generally continuously or in response to a signal from another device, such as the merchant device 110. The user's mobile device 120 can communication the user's preferred currency or preferred currencies in response to a user action, such as enabling the chip or initiating an app of a cellular telephone.

The range of the user's mobile device 120 for such communication can be the default or maximum range thereof. Alternatively, the range can be limited. For example, a limit of the range can be defined by a technician or by the user during a setup process for the user's mobile device 120.

Radio frequency identification (RFID) can be used to initiate communication between the user's mobile device 120 and the merchant device 110. For example, the merchant device 110 can include an RFID tag and the user's mobile device 120 can contain an RFID tag reader. When the user's mobile device 120 is within range of the RFID tag, the user's mobile device 120 can begin to transmit the user's preferred currency or a signal representative thereof.

As a further example, the user's mobile device 120 can include an RFID tag and the merchant device 110 can contain the RFID tag reader. When the merchant device 110 is within range of the RFID tag, the merchant device 110 can transmit a signal to the user's mobile device requesting the user's preferred currency.

The memory 122 of the user's device can contain location information for the display 113. This information can be updated frequently, e.g., daily, to maintain the accuracy thereof. This location information can be used by the user's mobile device 120 to facilitate broadcasting of the user's preferred currency. For example, the memory 122 can contain the location of stores that participate in the currency conversion system and the user's mobile device 120 can broadcast the user's preferred currency when the user is in or near a participating store.

The merchant device 110 can facilitate conversion of the product purchase price from the merchant's local currency to the user's preferred currency, as shown in step 204. The merchant device 110 can perform the conversion of the product purchase price from the merchant's local currency to the user's preferred currency. Alternatively, the merchant device 110 can communicate the user's preferred currency and the product price to another device, such as the server 130, which can perform the conversion.

As a further alternative, the user's mobile device 120 can perform the conversion. For example, the merchant device 110 can communicate the currency conversion rate and the merchant's local currency product price to the user's mobile device 120. The conversion can be performed by multiplying the merchant's local currency product price by the appropriate currency conversion rate to obtain the user's preferred currency.

The conversion can be performed using a lookup table, and algorithm, or any other means. For example, a conversion from pesos to U.S. dollars can be performed by accessing an entry in a table at the intersection of pesos and U.S. dollars to determine the conversion rate from pesos to U.S. dollars, and then the amount in pesos can be multiplied by the conversion rate to determine the amount in U.S. dollars.

The conversion can be performed using an algorithm. The algorithm can use a look up table, as discuss herein. The conversion rates, e.g., the lookup table, can be updated prior to performing a conversion. For example, the lookup table can be updated from a source of conversion rates, such as from a bank or currency exchange, via the Internet. Rather than using a lookup table, the algorithm can simply access, such as via the Internet, the necessary exchange rate.

Rather than performing the currency conversion, the merchant device 110, the mobile device 120, or the server 130 can access, such as via the Internet, a currency convertor. The currency convertor can be a web base currency convertor. The accessed currency converter can perform the currency conversion and can provide the result to the merchant device 110, the mobile device 120, or the server 130.

The merchant device 110 can show the product purchase price on the display 113 in the user's preferred currency, as shown in step 205. The prices shown on the display 113 can be in the local currency, the user's preferred currency, or both. The prices shown on the display can be in multiple currencies. The prices shown on the display can be in any desired currencies can be in any desired number of currencies. For example, if the user's mobile device 120 provides the merchant device 110 with a list of currencies, then the prices shown on the display 113 can be in the listed currencies and can be in the same order as the order of the list.

If multiple user's preferred currencies are shown on the display 113, the multiple user's preferred currencies can be shown simultaneously, such as one next to another or such as one below another. Alternatively, the multiple user's preferred currencies can be shown sequentially, such as to facilitate the user of a smaller display 113. The user's preferred currencies can be shown in any desired manner.

The prices in the local currency, the prices in the user's preferred currency, or both can be shown on the display 125 of the user's mobile device 120. The prices in the local currency, the prices in the user's preferred currency, or both can be shown on any desired display of any device. Where the preferred currency is shown on a merchant device or display, the communication between the user device and a merchant device is necessarily short range so that only the user in front of or within a short distance from the merchant device is shown the converted currency. This prevents the merchant display from inadvertently showing a preferred currency from another user. However, where the preferred currency is shown on the user device, the communication may be wider, such as when the user is near or in a merchant location. In this case, a plurality of users may see different currency conversions at the same time on their respective user devices.

FIG. 3 is a flow chart showing further detail of the method for converting and displaying currencies, according to an embodiment. A currency conversion rate for converting from a local currency of a merchant to a preferred currency of a user can be stored in one or more memories, as shown in step 301. The one or more memories can include the memory 111 of the merchant device, the memory 122 of the user's mobile device 120, and/or the memory 132 of the server. The one or more memories can include any desired memory or memories. The one or more memories can include any desired combination of memories.

A local currency product price can be stored in one or more memories, as shown in step 302. The local currency product price can be modified or update by the merchant, as desired. Again, the one or more memories can include the memory 111 of the merchant device, the memory 122 of the user's mobile device 120, and/or the memory 132 of the server. The one or more memories can include any desired memory or memories. The one or more memories can include any desired combination of memories.

A communication including an indication of the preferred currency of the user can be received by the processor 112 of the merchant device 110, as shown in step 303. For example, the user can be an American and the preferred currency of the user can be US dollars. The preferred currency of the user can be the user's native currency or any other currency. The communication can include an indication of any desired number of different preferred currencies.

The user's desired currency can be predefined, such as by the user during a set up process of the app 124. The user's desired currency can be defined substantially in real time, such as at the store. For example, the user can enter one or more desired currencies while shopping.

The merchant device 110 can be located proximate the product on the shelf of the store. The communication can be via near field communication that is initiated automatically when the user's mobile device comes into range with respect to the merchant device 110 located proximate a product on the shelf of the store. Thus, the indication of the preferred currency can be communicated to the processor 112 as the user approaches the product.

The currency conversion rate can be accessed in the one or more memories, as shown in step 304. The currency conversion rate can be accessed via a lookup table of currency exchange rates or by accessing only the necessary currency exchange rate, as discussed herein. The local currency product price can be accessed in the one or more memories, as shown in step 305. The preferred currency product price can be determined from the currency conversion rate and the local currency product price, as shown in step 306.

A signal for displaying the preferred currency product price can be communicated to a display (such as the display 113 of the merchant device 110), as shown in step 307. The signal can be used by the display to show the preferred currency product price, any messages, and/or any other information. Any desired display or combination of displays can be used, as discussed herein. According to this example, the product price can be displayed in U.S. dollars.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT, LED, or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

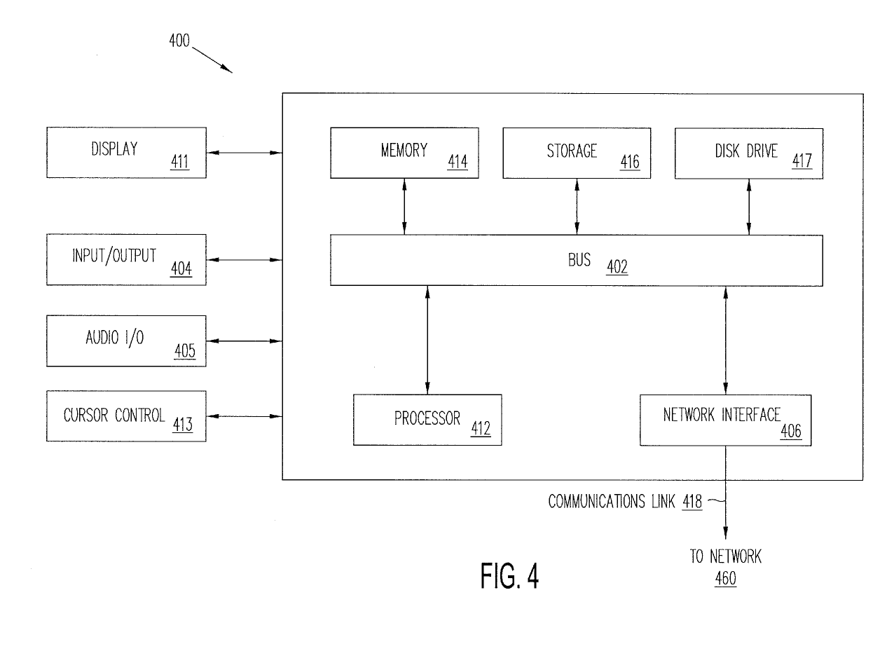

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “store” can include any business or place of business. The store can be a brick and mortar store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, automotive repair, haircuts, digital music, and books.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “local currency” can include a native currency with respect to the merchant. The local currency can be the currency used where the merchant is located. For example, if the merchant is located in Mexico, the native currency will be pesos. The local currency can be any currency that is not the preferred currency of the user.

As used herein, the term “near field communication (NFC)” can include any short communication between electronic devices. For example, near field communication can include radio communication, infrared (IR) communication, ultrasonic communication, and the like. Near field communication can be initiated by bringing two near field communication devices within range of one another and/or by tapping the two near field communication devices against one another.

As used herein, the term “preferred currency” can include a native currency of the user. For example, if the user is an American, the native currency will be U.S. dollars. According to an embodiment, the user can have more than one preferred currency, can list more than one preferred currency in a setup of the user's mobile device 120, and more than one preferred currency can be listed on the merchant's display 113 or the mobile device.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
one or more memories storing information about user accounts, where the information comprises an indication of a user's preferred currency;
one or more processors operable to:
receive a wireless communication from a mobile device of a user near or at a location for a merchant;
in response to receiving the wireless communication from the mobile device of the user, automatically determine, without the user's input, a preferred currency for the user based, at least in part, on information contained in the wireless communication;
convert a local price for an offering of the merchant using the preferred currency; and
communicate electronic information to display a converted price for the offering to the user.

2. The system of claim 1, wherein the converted price is displayed on the mobile device of the user.

3. The system of claim 1, wherein the converted price is displayed on a device of the merchant.

4. The system of claim 3, wherein the device of the merchant is a point of sale (POS) terminal.

5. The system of claim 3, wherein the device of the merchant is a display associated with the offering.

6. The system of claim 1, wherein the information comprises a phone number associated with the mobile device, and wherein the preferred currency is determined based on code of the phone number.

7. The system of claim 1, wherein the information comprises plurality of preferred currencies with an order of preference and wherein converted prices are displayed based on the order of preference.

8. The system of claim 1, wherein the location is a store.

9. The system of claim 1, wherein the wireless communication is received when the user is at a POS terminal.

10. The system of claim 1, wherein the wireless communication is received when the user is near the offering to trigger a display of the converted price, and wherein the converted price is removed from being displayed when the user departs from the offering and the wireless communication is no longer received.

11. A method comprising:
storing, in one or more memories, information about user accounts, where the information comprises an indication of a user's preferred currency;
receiving, electronically via one or more processors, a wireless communication from a mobile device of a user near or at a location for a merchant;
in response to receiving the wireless communication from the mobile device of the user, automatically without the user's input, determining, electronically via the one or more processors, a preferred currency for the user based, at least in part, on information contained in the wireless communication;
converting, electronically via the one or more processors, a local price for an offering of the merchant using the preferred currency; and
communicating, electronically via the one or more processors, electronic information to display a converted price for the offering to the user.

12. The method of claim 11, wherein the converted price is displayed on the mobile device of the user.

13. The method of claim 11, wherein the converted price is displayed on a device of the merchant.

14. The method of claim 13, wherein the device of the merchant is a point of sale (POS) terminal.

15. The method of claim 13, wherein the device of the merchant is a display associated with the offering.

16. The method of claim 11, wherein the information comprises a phone number associated with the mobile device, and wherein the preferred currency is determined based on a country code of the phone number.

17. The method of claim 11, wherein the information comprises a plurality of preferred currencies with an order of preference and wherein converted prices are displayed based on the order of preference.

18. The method of claim 11, wherein the location is a store.

19. The system of claim 11, wherein the wireless communication is received when the user is at a POS terminal.

20. The method of claim 11, wherein the wireless communication is received when the user is near the offering to trigger a display of the converted rice and wherein the converted price is removed from being displayed when the user departs from the offering and the wireless communication is no longer received.

21. A computer program product comprising a non-transitory computer readable medium having computer readable and executable code for instructing one or more processors to perform a method, the method comprising:
storing information about user accounts, where the information comprises an indication of a user's preferred currency;
receiving a wireless communication from a mobile device of a user near or at a location for a merchant;
in response to receiving the wireless communication from the mobile device of the user, automatically determining without the user's input, a preferred currency for the user based, at least in part, on information contained in the wireless communication;
converting a local price for an offering of the merchant using the preferred currency; and
communicating electronic information to display a converted price for the offering to the user.
